(19) United States
(12) Patent Application Publication
(10) Pub. No.: US 2024/0419990 A1
(43) Pub. Date: Dec. 19, 2024

(54) COMPUTER-READABLE RECORDING MEDIUM STORING CORRESPONDENCE RELATIONSHIP DETERMINATION PROGRAM, CORRESPONDENCE RELATIONSHIP DETERMINATION METHOD, AND INFORMATION PROCESSING DEVICE

(71) Applicant: Fujitsu Limited, Kawasaki-shi (JP)

(72) Inventors: Hitoshi YANAMI, Kawasaki (JP); Masatoshi OGAWA, Zama (JP); Hiroyuki SHIMODA, Nagano (JP); Toshiyuki KOBAYASHI, Nagano (JP)

(73) Assignee: Fujitsu Limited, Kawasaki-shi (JP)

(21) Appl. No.: 18/731,716

(22) Filed: Jun. 3, 2024

(30) Foreign Application Priority Data
Jun. 16, 2023 (JP) 2023-099691

(51) Int. Cl. G06N 5/04

(52) U.S. Cl. CPC G06N 5/04

(57) ABSTRACT

A computer-readable recording medium stores a correspondence relationship determination program for causing a computer to execute a process. The process includes: acquiring, using a first machine learning model that infers individual figure information regarding one line segment in a first plurality of line segments included in first figure data and a second machine learning model that infers information regarding a relative relationship between the one line segment in the first plurality of line segments and another line segment in the first figure data, an inference result of each of a plurality of items that includes the individual figure information and the information regarding the relative relationship; and determining correspondence relationships between the first plurality of line segments and a second plurality of line segments included in second figure data different from the first figure data based on the inference result of each of the plurality of items.

### CROSS-REFERENCE TO RELATED APPLICATION

This application is based upon and claims the benefit of priority of the prior Japanese Patent Application No. 2023-99691, filed on Jun. 16, 2023, the entire contents of which are incorporated herein by reference.

### FIELD

The embodiment discussed herein is related to machine learning.

### BACKGROUND

There is known a technology of determining description positions of dimensional annotations (dimensional notations) based on features of a drawing entity in a case where one or more drawing entities are selected in an operation screen of a computer aided design (CAD).

Japanese Laid-open Patent Publication No. 2019-8664, Japanese Laid-open Patent Publication No. 7-230482, U.S. Patent Publication No. 2014/0306956, and U.S. Patent Publication No. 2008/0126023 are disclosed as related art.

### SUMMARY

According to an aspect of the embodiments, a computer-readable recording medium storing a correspondence relationship determination program for causing a computer to execute a process including: acquiring, using a first machine learning model that infers individual figure information regarding one line segment in a first plurality of line segments included in first figure data and a second machine learning model that infers information regarding a relative relationship between the one line segment in the first plurality of line segments and another line segment in the first figure data, an inference result of each of a plurality of items that includes the individual figure information and the information regarding the relative relationship, for each of the first plurality of line segments; and determining correspondence relationships between the first plurality of line segments and a second plurality of line segments included in second figure data different from the first figure data based on the inference result of each of the plurality of items for each of the first plurality of line segments.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of past figure data and newly created figure data;

FIG. 2 is a diagram for describing an outline of processing in an inference phase by an information processing device according to an embodiment;

FIG. 3 is a diagram for describing an outline of processing in a training phase by the information processing device according to the embodiment;

FIG. 4 is a diagram illustrating an example of items to be trained and inferred for each of a plurality of line segments included in figure data;

FIG. 5 is a diagram illustrating an example of a configuration in the training phase in a case where the information processing device according to the embodiment is applied to a drawing creation system;

FIG. 6 is a diagram illustrating an example of a configuration in the inference phase in a case where the information processing device according to the embodiment is applied to the drawing creation system;

FIG. 7 is a block diagram illustrating a hardware (HW) configuration example of a computer that implements functions of the information processing device according to the embodiment;

FIG. 8 is a block diagram illustrating a functional configuration example in the training phase by the information processing device according to the embodiment;

FIG. 9 is a block diagram illustrating a functional configuration example in the inference phase by the information processing device according to the embodiment;

FIG. 10 is an example of line segment feature data indicating a relationship between each line segment and features in the past figure data;

FIG. 11 is an example of inference results using a second figure internal direction determination model;

FIG. 12 is a diagram illustrating an example of a voting method using the inference results;

FIG. 13 is an example of an aggregation result table using the inference results;

FIG. 14 is an example of the aggregation result table using the inference results;

FIG. 15 is an example of an N square matrix for calculating a correspondence relationship between each line segment in the past figure data and each line segment in the newly created figure data;

FIG. 16 is an example of an N−1 square matrix obtained by removing a row and a column for which association has been completed;

FIG. 17 is a diagram illustrating another example of the voting method using the inference results;

FIG. 18 is a diagram for describing correction of association using one-to-one correspondence;

FIG. 19 is a flowchart illustrating an example of operation in the training phase by the information processing device according to the embodiment;

FIG. 20 is a flowchart illustrating an example of operation in the inference phase by the information processing device according to the embodiment; and

FIG. 21 is a diagram illustrating an example of a working example.

### DESCRIPTION OF EMBODIMENTS

In a case where a drawing similar to a drawing created in the past is newly created, it may be desired to add dimensional annotations of description positions and modes similar to those in the past drawing to the newly created drawing from a viewpoint of a rule unique to a drawing user, and the like. For that purpose, as a premise, correspondence relationships between line segments between a figure (drawing entity) in the past drawing and a figure in the newly created drawing are determined using a machine learning model or the like. The description positions and the modes of the dimensional annotations are determined based on the determined correspondence relationships between the line segments.

However, in a case where machine learning is performed using similar drawings created in the past as training data, the training data for the machine learning may not be sufficiently prepared due to the number of the drawings created in the past. It is desirable to reduce an amount of the training data for determining correspondence relationships of line segments between the plurality of drawings. Also in applications other than dimensioning of a drawing, it is desired to reduce the amount of the training data for improving accuracy of determining the correspondence relationships of the line segments between the plurality of pieces of figure data.

In one aspect, an object of an embodiment is to reduce an amount of training data for determining correspondence relationships of line segments between a plurality of pieces of figure data.

Hereinafter, an embodiment will be described with reference to the drawings. Note that the embodiment to be described below is merely an example, and there is no intention to exclude application of various modifications and technologies not explicitly described in the embodiment. For example, the present embodiment may be variously modified and implemented in a range without departing from the spirit thereof. Furthermore, each drawing does not intend to include only components illustrated in the drawing and may include another component.

### [A] Description of Correspondence Relationship Determination Method

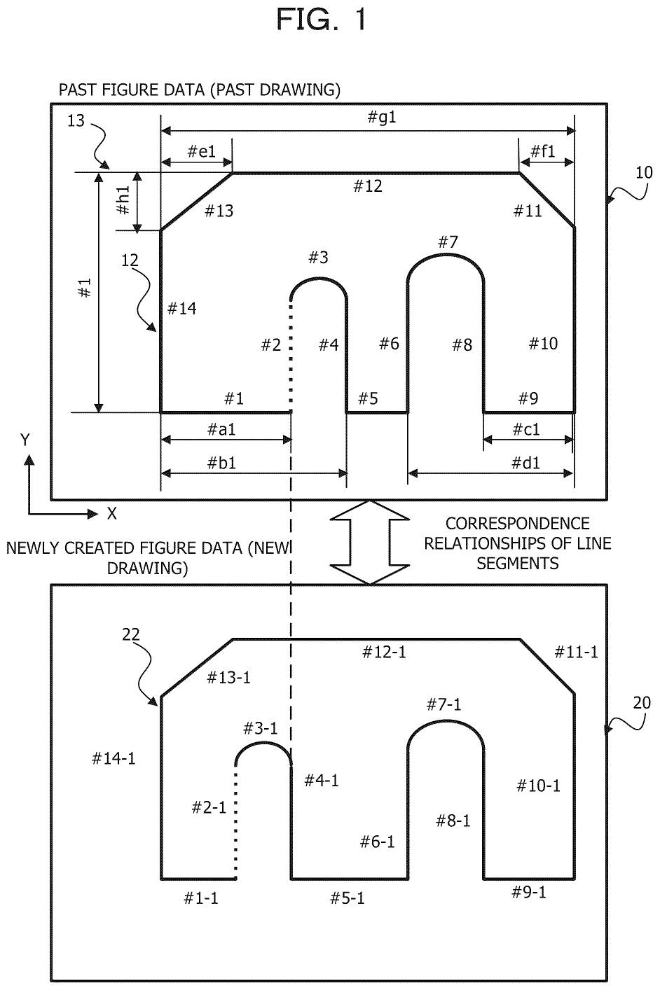

FIG. 1 is a diagram illustrating an example of past figure data 10 and newly created figure data 20.

In an example, the past figure data 10 is drawing data created in the past. In an example, the newly created figure data 20 is drawing data to be newly created. The past figure data 10 and the newly created figure data 20 may be created using computer aided design (CAD) software at a design stage.

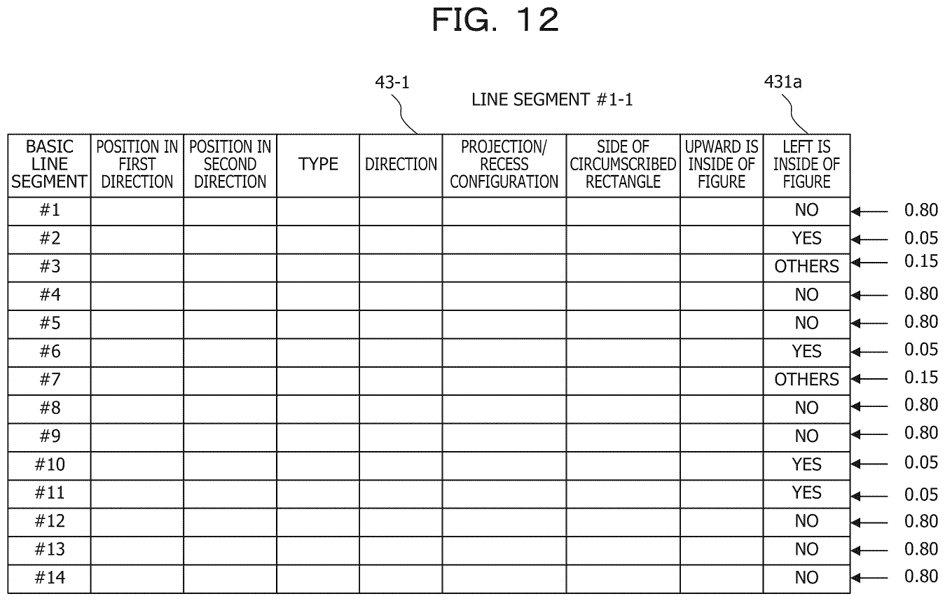

The past figure data 10 includes a FIG. 12. Similarly, the newly created figure data 20 includes a FIG. 22. In the present specification, a “figure” is a line segment set or a drawing entity including a plurality of line segments. The “inside of the figure” means an internal space surrounded by a closed figure in a case where the figure includes the closed figure. The “outside of the figure” means a portion other than the internal space surrounded by the closed figure.

In FIG. 1, line segments #1 to #14 included in the past figure data 10 constitute sides (for example, a contour) of the FIG. 12 that is a closed figure. Line segments #1-1 to #14-1 included in the newly created figure data 20 constitute sides of the FIG. 22 that is a closed figure. Note that, unlike FIG. 1, each of the past figure data 10 and the newly created figure data 20 may include a line segment that does not constitute a side of the closed figure.

Dimensional annotations 13 (for example, dimensional annotations #a1 to #h1) representing information such as lengths and radii of arcs of the line segments #1 to #14 are added to the past figure data 10. The dimensional annotations 13 includes one or more of a dimension line, an auxiliary line (for example, a lead line), and a dimensional numerical value. The dimensional annotations 13 are examples of second dimensional notations.

There are various dimensioning rules (for example, dimensioning conventions) for notation positions and modes of the dimensional annotations 13 depending on an industry type, business, a company, a department, and the like.

In a case where an automatic dimensioning function attached to the CAD software is used, a computer calculates positions to which dimensions are to be assigned in correspondence with the line segments #1-1 to #14-1 of the FIG. 22, and automatically adds lead lines and the dimensions. However, depending on the automatic dimensioning function, it is difficult to implement dimensional annotations of positions and modes that conform to the dimensioning rule. Furthermore, redundant dimensioning may be provided. Therefore, a drawer checks automatically added dimensions, and the drawer manually corrects dimensional annotations and the like in modes different from those of the dimensioning rule. Each time the design is changed, the manual correction portions may be reset, and automatic dimensioning and manual correction are repeated, which increases a work load.

Since a manufacturer or the like may design similar products, the past figure data 10 similar to the newly created figure data 20 may be possessed as drawing data. Therefore, in a case where dimensional annotation are newly added to the newly created figure data 20, a method of determining the dimensional annotations 13 conforming to the dimensioning rule similar to that of the past figure data 10 by following the dimensional annotations 13 of the past figure data 10 may be considered. As a premise for that, the computer determines which of the respective line segments #1-1 to #14-1 of the newly created figure data 20 (for example, the newly created drawing) corresponds to which of the line segments #1 to #14 of the past figure data 10.

A method of using an image to determine which line segment of the past figure data 10 (for example, the past drawing) is closest to one line segment among the plurality of line segments #1-1 to #14-1 of the newly created figure data 20 may be considered. For example, there is a method of associating the line segments by searching for line segments having positions of centers of gravity closest to each other between the line segments #1 to #14 and the line segments #1-1 to #14-1. Furthermore, there is a method of associating the line segments by searching for line segments having positions of both end points closest to each other between the line segments #1 to #14 and the line segments #1-1 to #14-1.

However, in the case of these methods, in a case where positions of centers of gravity or both end points of line segments not in a correspondence relationship (#2 of the FIG. 12 and #4-1 of the FIG. 22) approximate to each other as in the FIG. 12 and the FIG. 22 illustrated in FIG. 1, it is difficult to determine a correct correspondence relationship. It is determined that the line segment #2 of the FIG. 12 corresponds to the line segment #4-1 of the FIG. 22, although there is no correspondence relationship therebetween.

As another association method, it may be considered to determine a correspondence relationship of line segments between a plurality of pieces of figure data using machine learning. In an example, the past figure data 10 that is the past drawing created in the past and is similar to the drawing to be newly created is utilized as training data to create a machine learning model subjected to training using association between the figure line segments in the newly created drawing and the figure line segments in the past drawing.

Image data in which information such as color of one line segment (for example, the line segment #1) is changed among the plurality of line segments #1 to #14 included in the past figure data 10 is created. In an example, the line segment may be set to red, and other line segments may be set to black. Training data in which the image data is associated with a line segment number (#1) which is a correct answer label is created. The line segment number may be a number that specifies the line segment. Similarly, when there are 14 line segments in the past figure data 10, similar training data is created for the number of line segments (in this example, 14 patterns). A machine learning model including a deep neural network (DNN) or the like is trained using the training data created based on the plurality of similar patterns of past figure data 10. For example, parameters of the neural network are adjusted.

A control unit 110 uses the trained machine learning model to infer which line segment number of the past figure data 10 the newly created figure data 20 corresponds to. In an example, image data to be inferred in which information such as color of one line segment (for example, the line segment #1-1) is changed among the plurality of line segments #1-1 to #14-1 included in the newly created figure data 20 is created. The trained machine learning model infers the corresponding line segment number (#1). As a result, a correspondence relationship of the line segments between the plurality of pieces of figure data is determined.

However, according to research of the inventors of this disclosure, in order to set a correct answer rate of the line segment number determination in the newly created figure data 20 to 90%, about 1000 pieces of the past figure data 10 are needed in order to create the training data. Although the manufacturer or the like possesses the past figure data 10 similar to the newly created figure data 20 as drawing data by designing similar products, the number of pieces of the past figure data 10 is often less than 1000. Thus, an information processing device of the embodiment improves accuracy of determining a correspondence relationship of line segments between a plurality of pieces of figure data even in a case where training data may not be sufficiently prepared. Hereinafter, the information processing device will be described.

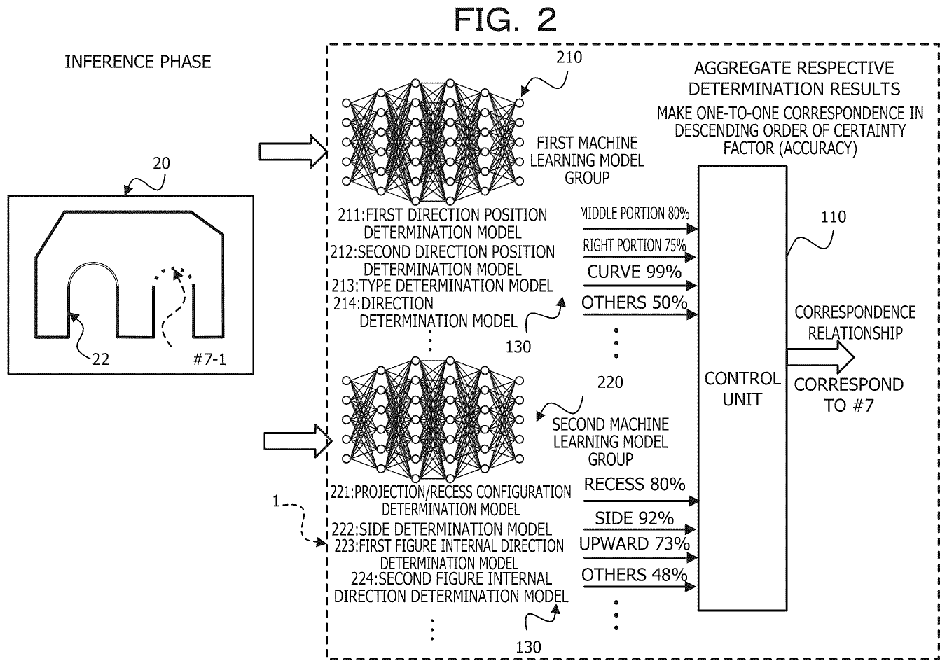

FIG. 2 is a diagram for describing an outline of processing in an inference phase by an information processing device 1 according to the embodiment.

The information processing device 1 is a computer. The information processing device 1 includes the control unit 110. In this example, the information processing device 1 includes a first machine learning model group 210 and a second machine learning model group 220. Note that the first machine learning model group 210 and the second machine learning model group 220 may be provided outside the information processing device 1.

The first machine learning model group 210 infers individual figure information of one line segment among the plurality of line segments #1-1 to #14-1 for each of the line segments #1-1 to #14-1 included in the newly created figure data 20. The first machine learning model group 210 exemplarily includes a first direction position determination model 211, a second direction position determination model 212, a type determination model 213, and a direction determination model 214. Note that the first machine learning model group 210 may include other types of machine learning models than these types of machine learning models. The first machine learning model group 210 may be one first machine learning model 210a. The first machine learning model group 210 and the first machine learning model 210a may be collectively referred to as the first machine learning model group 210. The first machine learning model group 210 is an example of at least one first machine learning model. The newly created figure data 20 is an example of first figure data. The line segments #1-1 to #14-1 are examples of a first plurality of line segments.

The second machine learning model group 220 infers a relative relationship between one line segment among the line segments #1-1 to #14-1 and one or more other line segments in the newly created figure data 20 for each of the line segments #1-1 to #14-1 included in the newly created figure data 20. The relative relationship is a graphical relationship. The second machine learning model group 220 includes a projection/recess configuration determination model 221, a side determination model 222, a first figure internal direction determination model 223, and a second figure internal direction determination model 224. Note that the second machine learning model group 220 may include other types of machine learning models than these types of machine learning models. The second machine learning model group 220 may be one second machine learning model 220a. The second machine learning model group 220 and the second machine learning model 220a may be collectively referred to as the second machine learning model group 220. The second machine learning model group 220 is an example of at least one second machine learning model.

Each machine learning model included in the first machine learning model group 210 and the second machine learning model group 220 may be a deep neural network (DNN)-based feature detection model in which a hidden layer (intermediate layer) is multilayered between an input layer and an output layer.

The control unit 110 executes arithmetic operation and control of the information processing device 1. For each of the line segments #1-1 to #14-1 included in the newly created figure data 20, the control unit 110 uses the first machine learning model group 210 and the second machine learning model group 220 to acquire inference results 130 of a plurality of items including the individual figure information and information regarding the relative relationship. Based on the inference results 130, the control unit 110 determines correspondence relationships between the line segments #1-1 to #14-1 and the plurality of line segments #1 to #14 included in the past figure data 10. The control unit 110 determines line segment numbers (#1 to #14) in the past figure data 10 for the line segments #1-1 to #14-1. For example, the control unit 110 determines the line segment number (#7) as the line segment correspondence relationship.

Note that, as illustrated in FIG. 2, class determination results (for example, the inference results 130) by the respective machine learning models included in the first machine learning model group 210 and the second machine learning model group 220 may include a feature to be inferred and a certainty factor in the inference. For example, the first direction position determination model 211 outputs inference of a feature that a line segment is positioned in a central portion and a certainty factor of the inference which is 80%. The number of the respective machine learning models included in the first machine learning model group 210 and the second machine learning model group 220 depends on the number of features to be inferred.

The past figure data 10 is an example of second figure data different from the newly created figure data 20. The line segments #1 to #14 are examples of a second plurality of line segments. Note that the number of each of the line segments #1 to #14 and the line segments #1-1 to #14-1 is not limited to the case of 14.

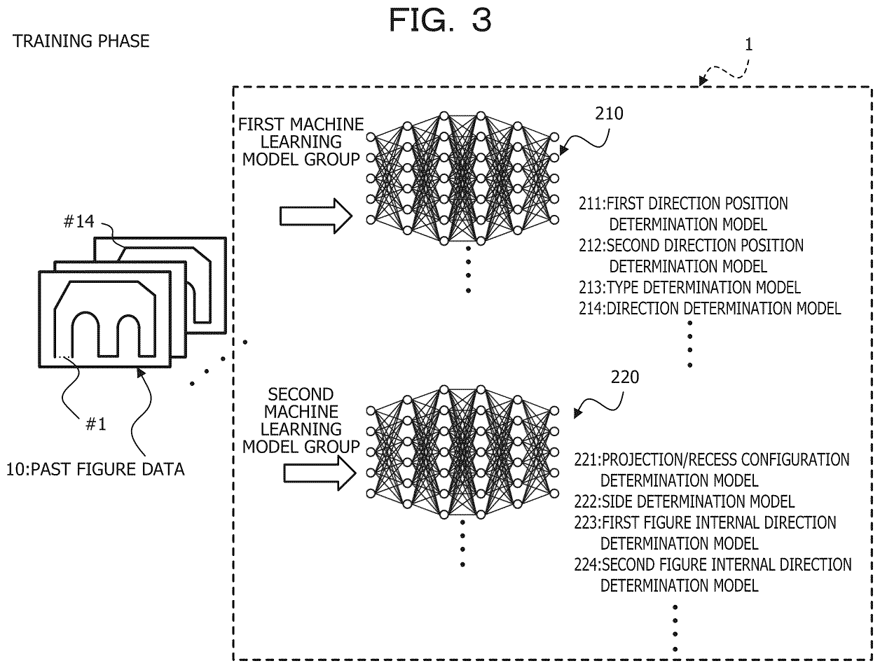

FIG. 3 is a diagram for describing an outline of processing in a training phase by the information processing device 1 according to the embodiment. The first machine learning model group 210 and the second machine learning model group 220 are trained based on the past figure data 10.

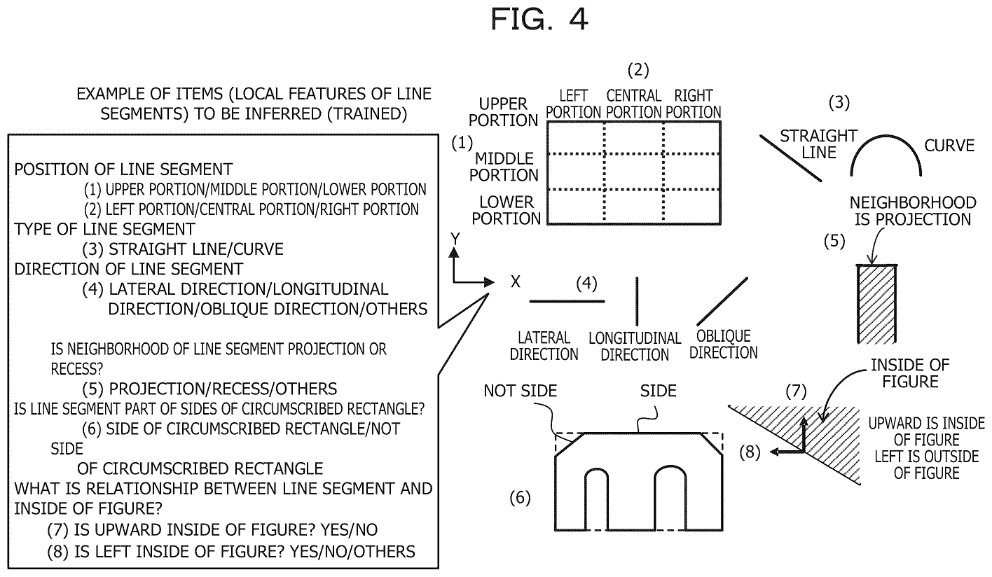

In FIGS. 2 and 3, each of the first machine learning model group 210 and the second machine learning model group 220 is subjected to training and performs inference regarding local features of the line segments #1-1 to #14-1. The local feature is an example of the item for the individual figure information or the information regarding the relative relationship. The plurality of types of local features including both the individual figure information and the information regarding the relative relationship is an example of the plurality of items including the individual figure information and the information regarding the relative relationship. Hereinafter, the first machine learning model group 210 and the second machine learning model group 220 will be described with reference to FIG. 4. In this example, the machine learning models are provided according to the number of the plurality of items, for example, the number of local features.

FIG. 4 is a diagram illustrating an example of items to be trained and inferred for each of the plurality of line segments (#1 to #14 and #1-1 to #14-1) included in the figure data. The plurality of items includes items related to the individual figure information of the line segments (reference numerals (1) to (4) in FIG. 4) and items related to the relative relationship between the plurality of line segments (reference numerals (5) to (8) in FIG. 4). The individual figure information may include at least one piece of information of a position of a line segment (reference numerals (1) and (2) in FIG. 4), a direction of the line segment (reference numeral (3) in FIG. 4), and a curvature of the line segment (reference numeral (4) in FIG. 4). The relative relationship between the plurality of line segments may include information regarding whether or not one line segment constitutes a recess portion or a projection portion of the closed figure (FIG. 22) of the newly created figure data 20 (reference numeral (5) in FIG. 4). The relative relationship between the plurality of line segments may include information regarding whether or not one line segment constitutes a side of a circumscribed rectangle for the closed figure (FIG. 22) of the newly created figure data 20 (reference numeral (6) in FIG. 4). The relative relationship between the plurality of line segments may include information regarding a relationship between one line segment and the inside of the closed space in the first figure data (reference numerals (7) and (8) in FIG. 4).

In an example, the first direction position determination model 211 infers classes of an upper portion, a middle portion, and a lower portion as a first direction position of a line segment (reference numeral (1) in FIG. 4). The first direction position of the line segment is a position in a first direction where the line segment is positioned in a drawing plane of the figure data. The first direction means one direction in the drawing plane, and is, for example, a Y direction in FIG. 1. In FIG. 4, the first direction may be a longitudinal direction.

In an example, the second direction position determination model 212 infers classes of a left portion, a central portion, and a right portion as a second direction position of the line segment (reference numeral (2) in FIG. 4). The second direction position of the line segment is a position in a second direction where the line segment is positioned in the drawing plane of the figure data. The second direction is a direction orthogonal to the first direction. For example, the second direction is an X direction in FIG. 1. In FIG. 4, the second direction may be a lateral (or horizontal) direction. The first direction position determination model 211 and the second direction position determination model 212 are examples of machine learning models that infer a position of a line segment.

The type determination model 213 infers whether the line segment is a straight line or a curve (reference numeral (3) in FIG. 4). For example, the type determination model 213 is an example of a machine learning model that infers a curvature of a line segment.

In an example, the direction determination model 214 infers classes of the longitudinal direction, the lateral direction, and an oblique direction as a direction of the line segment. A direction of a line segment having an inclination within a predetermined angle relative to a Y axis may be classified as the longitudinal direction, a direction of a line segment having an inclination within a predetermined angle relative to an X axis may be classified as the lateral direction, and a direction of a line segment having an inclination of an angle between the longitudinal direction and the lateral direction may be classified as the oblique direction (reference numeral (4) in FIG. 4). In a case where a line segment is a curve and a direction in which the line segment extends changes, the direction determination model 214 may infer that the direction of the line segment is “others”. The direction determination model 214 is an example of a machine learning model that infers a direction of a line segment.

The projection/recess configuration determination model 221 infers whether the line segment corresponds to a case where the line segment cooperates with line segments coupled at both ends to constitute the projection portion of the FIG. 22 that is the closed figure, corresponds to a case where the line segment constitutes the recess portion, or corresponds to other cases (reference numeral (5) in FIG. 4). Taking the FIG. 22 in FIG. 1 as an example, the line segment #1-1 constitutes the projection portion of the FIG. 22 in cooperation with the line segment #2-1 and the line segment #14-1 coupled at both ends. The line segment #3-1 constitutes the recess portion of the FIG. 22 in cooperation with the line segment #2-1 and the line segment #4-1 coupled at both ends. The line segment #2-1 constitutes neither the projection portion nor the recess portion in cooperation with the line segment #1-1 and the line segment #3-1 coupled at both ends, and thus corresponds to “others”.

The side determination model 222 infers whether or not the line segment constitutes a side of the circumscribed rectangle of the FIG. 22 that is the closed figure (reference numeral (6) in FIG. 4). The circumscribed rectangle is the smallest rectangle that may surround the FIG. 22.

The first figure internal direction determination model 223 infers whether or not the first direction is the inside of the FIG. 22 that is the closed figure with reference to the line segment. The first direction may be a positive direction of the Y axis in FIG. 1. The first direction may be an upward direction or a downward direction. In this example, the first direction is the upward direction. Note that the first figure internal direction determination model 223 may determine that the line segment corresponds to “others” in a case where the first direction (for example, upward direction) of the line segment changes between the state inside of the closed figure and the state outside of the closed figure due to a reason such as a curve of the line segment.

The second figure internal direction determination model 224 infers whether or not the second direction is the inside of the FIG. 22 that is the closed figure with reference to the line segment. The second direction may be a negative direction of the X axis in FIG. 1. The second direction may be a left direction or a right direction. In this example, the second direction is the left direction. Note that the second figure internal direction determination model 224 may determine that the line segment corresponds to “others” in a case where the second direction (for example, left direction) of the line segment changes between the state inside of the closed figure and the state outside of the closed figure due to a reason such as a curve of the line segment.

For example, the line segment #2 of the past figure data 10 in FIG. 1 is inferred by the second figure internal direction determination model 224 that the second direction (for example, left direction) of the line segment is the state inside of the closed figure (YES). On the other hand, the line segment #4-1 of the newly created figure data 20 in FIG. 1 is inferred by the second figure internal direction determination model 224 that the second direction (for example, left direction) of the line segment is the state outside of the closed figure (NO). Therefore, in the processing based on positions of centers of gravity and both end points of line segments, even in a case where it is difficult to determine a correspondence relationship of the line segments, it is possible to determine the correspondence relationship of the line segments by considering both local features for individual figure information and local features for information regarding a relative relationship with another line segment.

### [B] Description of Drawing Creation System

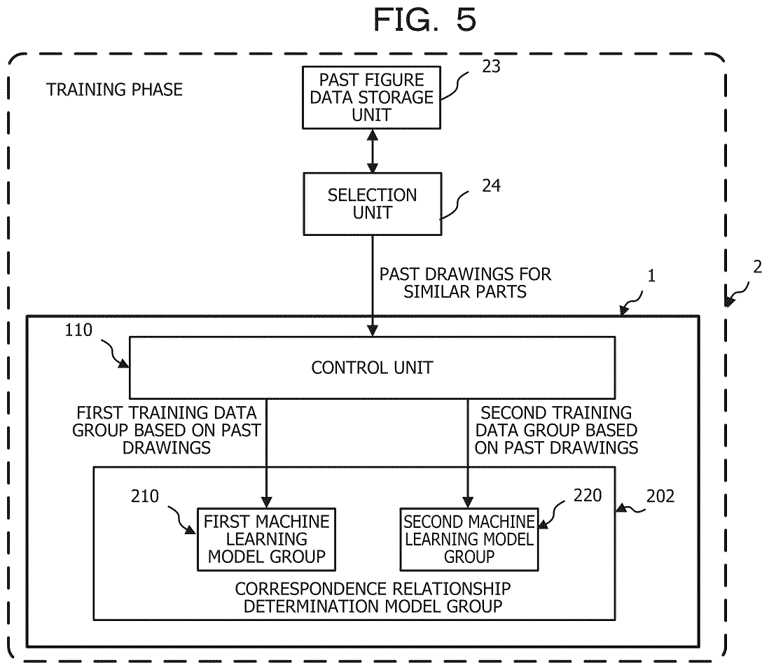

FIG. 5 is a diagram illustrating an example of a configuration in the training phase in a case where the information processing device 1 according to the embodiment is applied to a drawing creation system 2.

The drawing creation system 2 includes a past figure data storage unit 23 and a selection unit 24. The past figure data storage unit 23 stores a plurality of pieces of similar drawing data created in the past in association with each other. In an example, the plurality of pieces of similar drawing data may be stored and managed by identification information or the like.

The selection unit 24 selects the plurality of pieces of similar drawing data stored in association with each other based on the identification information. The plurality of pieces of similar drawing data corresponds to past drawings for similar parts. For example, the control unit 110 acquires the plurality of pieces of similar drawing data as a plurality of pieces of the past figure data 10.

The control unit 110 creates a plurality of pieces of figure data in which information such as color of one line segment (for example, the line segment #1) is changed among the plurality of line segments #1 to #14 included in the plurality of past figure data 10. The control unit 110 creates first training data in which the figure data and a correct answer label of one piece of the individual figure information are associated with each other for each line segment. The control unit 110 creates a first training data group by associating each piece of the figure data with the correct answer label of each piece of the individual figure information such as the reference numerals (1) to (4) in FIG. 4.

Similarly, the control unit 110 creates second training data in which the figure data and one piece of the information regarding a relative relationship are associated with each other for each line segment. The control unit 110 creates a second training data group by associating the figure data with a correct answer label of each relative relationship such as the reference numerals (5) to (8) in FIG. 4.

The control unit 110 trains the first machine learning model group 210 using the first training data group. The control unit 110 trains the second machine learning model group 220 using the second training data group. Note that the first machine learning model group 210 and the second machine learning model group 220 may constitute a correspondence relationship determination model group 202.

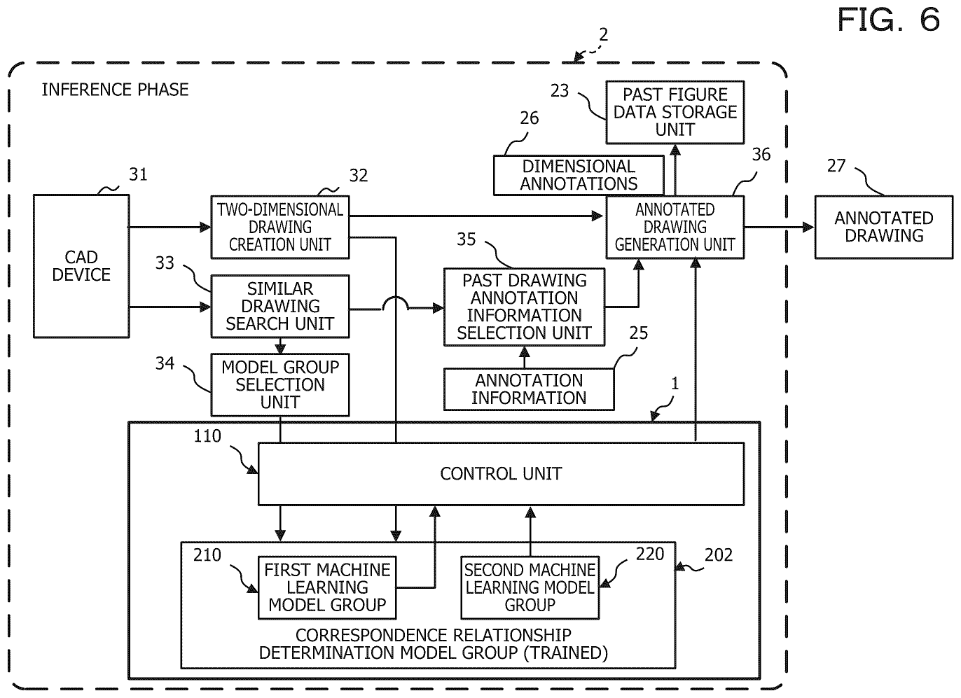

FIG. 6 is a diagram illustrating an example of a configuration in the inference phase in a case where the information processing device 1 according to the embodiment is applied to the drawing creation system 2.

The drawing creation system 2 includes a CAD device 31, a two-dimensional drawing creation unit 32, a similar drawing search unit 33, a model group selection unit 34, a past drawing annotation information selection unit 35, an annotated drawing generation unit 36 for generating annotated drawings 27, and the past figure data storage unit 23.

The CAD device 31 may be a three-dimensional CAD. The two-dimensional drawing creation unit 32 creates new two-dimensional drawing data. The two-dimensional drawing creation unit 32 may create two-dimensional drawing data based on three-dimensional CAD data in the CAD device 31. Identification information may be added to the two-dimensional drawing data. The created two-dimensional drawing data is an example of the newly created figure data 20.

The similar drawing search unit 33 searches for similar past drawings based on the identification information and the like regarding the two-dimensional drawing data created by the two-dimensional drawing creation unit 32. The model group selection unit 34 selects the trained correspondence relationship determination model group 202 trained by the similar past drawings based on a search result by the similar drawing search unit 33. For example, the model group selection unit 34 selects the first machine learning model group 210 and the second machine learning model group 220 that have been trained.

The control unit 110 creates image data to be inferred in which information such as color of one line segment (for example, the line segment #1-1) is changed among the plurality of line segments #1-1 to #14-1 included in the newly created figure data 20. The control unit 110 uses the selected first machine learning model group 210 and second machine learning model group 220 that have been trained, to infer a plurality of types of local features of the corresponding line segment number (#1). The control unit 110 determines a correspondence relationship between line segments based on the inference results 130 of the plurality of types of local features.

The past drawing annotation information selection unit 35 selects corresponding dimensional annotation information 25 based on the identification information and the like regarding the two-dimensional drawing data. The dimensional annotation information 25 includes a line segment to which a dimensional annotation is to be added, a position to which the dimensional annotation is to be added, a mode of adding the dimensional annotation, and the like. The dimensional annotation information 25 satisfies the dimensioning rule. The past drawing annotation information selection unit 35 acquires the dimensional annotation information 25 added to a part of the line segments #1 to #14 of the plurality of pieces of past figure data 10.

The annotated drawing generation unit 36 newly adds, based on the correspondence relationship determined by the control unit 110, dimensional annotations 26 in the newly created figure data 20 in correspondence with the positions and the modes in which the dimensional annotations 13 have been added in the past figure data 10. As a result, in the newly created figure data 20, the new dimensional annotations 26 are added according to the dimensioning rule similar to that of the past figure data 10. The annotated drawing generation unit 36 may be a part of the control unit 110. The dimensional annotations 26 are examples of the second dimensional notations.

### [C] Hardware Configuration Example

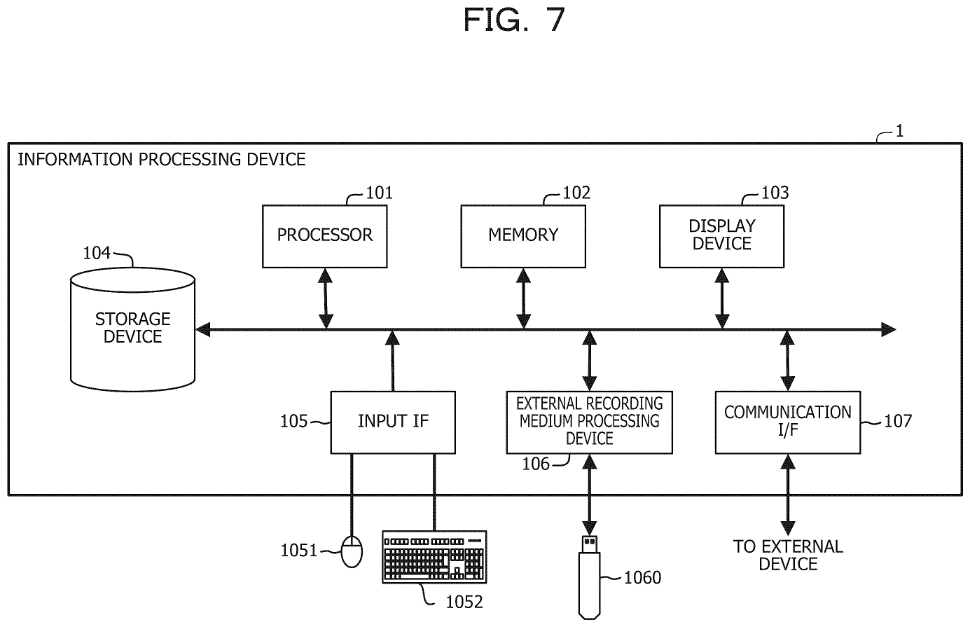

FIG. 7 is a block diagram illustrating a hardware (HW) configuration example of a computer that implements functions of the information processing device 1 according to the embodiment.

As illustrated in FIG. 7, the information processing device 1 includes a processor 101, a memory 102, a display device 103, a storage device 104, an input interface (IF) 105, an external recording medium processing device 106, and a communication IF 107.

The memory 102 is exemplarily a read only memory (ROM), a random access memory (RAM), or the like. In the ROM of the memory 102, programs such as a basic input/output system (BIOS) may be written. A software program of the memory 102 may be appropriately read and executed by the processor 101. Furthermore, the RAM of the memory 102 may be used as a temporary recording memory or a working memory.

The display device 103 is a liquid crystal display, an organic light-emitting diode (OLED) display, a cathode ray tube (CRT), an electronic paper display, or the like, and displays various types of information for an operator or the like. The display device 103 may be combined with an input device and may be, for example, a touch panel.

The storage device 104 is a storage device having high input/output (IO) performance, and for example, a dynamic random access memory (DRAM), a solid state drive (SSD), a storage class memory (SCM), or a hard disk drive (HDD) may be used.

The input IF 105 may be coupled to an input device such as a mouse 1051 and a keyboard 1052, and may control the input device such as the mouse 1051 and the keyboard 1052. The mouse 1051 and the keyboard 1052 are examples of the input devices, and an operator performs various types of input operation via these input devices.

The external recording medium processing device 106 is configured so that a recording medium 1060 may be attached thereto. The external recording medium processing device 106 is configured in such a manner that information recorded in the recording medium 1060 may be read in a state where the recording medium 1060 is attached. In this example, the recording medium 1060 is portable. For example, the recording medium 1060 is a flexible disk, an optical disk, a magnetic disk, a magneto-optical disk, a semiconductor memory, or the like.

The communication IF 107 is an interface for enabling communication with an external device.

The processor 101 is an example of a computer, and is a processing device that performs various types of control and arithmetic operation. The processor 101 implements various functions by executing an operating system (OS) or a program read in the memory 102. Note that the processor 101 may be a central processing unit (CPU), a multiprocessor including a plurality of CPUs, a multi-core processor having a plurality of CPU cores, or may have a configuration having a plurality of multi-core processors.

A device for controlling operation of the entire information processing device 1 is not limited to the CPU, and may be, for example, any one of a GPU, an MPU, a DSP, an ASIC, a PLD, or an FPGA. Furthermore, the device for controlling operation of the entire information processing device 1 may be a combination of two or more types of the CPU, GPU, MPU, DSP, ASIC, PLD, and FPGA. Note that the GPU is an abbreviation for a graphics processing unit, the MPU is an abbreviation for a micro processing unit, the DSP is an abbreviation for a digital signal processor, and the ASIC is an abbreviation for an application specific integrated circuit. Furthermore, the PLD is an abbreviation for a programmable logic device, and the FPGA is an abbreviation for a field programmable gate array.

The HW configuration of the information processing device 1 described above is an example. Therefore, an increase or decrease in the HW (for example, addition or deletion of an optional block), division, integration in an optional combination, addition or deletion of a bus, or the like in the information processing device 1 may be appropriately performed.

### [C] Functional Configuration Example

### [C-1] Training Phase

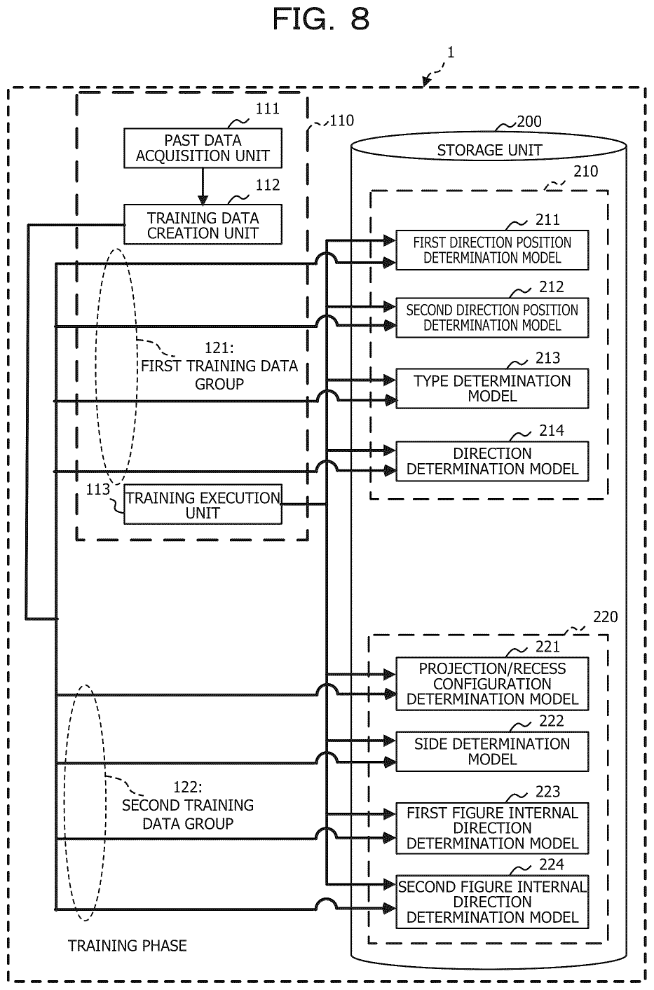

FIG. 8 is a block diagram illustrating a functional configuration example in the training phase by the information processing device 1 according to the embodiment.

The information processing device 1 includes the control unit 110 and a storage unit 200. The control unit 110 includes a past data acquisition unit 111, a training data creation unit 112, and a training execution unit 113.

The storage unit 200 is an example of a storage area, and stores various types of data to be used by the control unit 110. The storage unit 200 may be implemented by, for example, a storage area included in one or both of the memory 102 and the storage device 104 illustrated in FIG. 7.

As illustrated in FIG. 8, the storage unit 200 may exemplarily store the first machine learning model group 210 and the second machine learning model group 220.

As described with reference to FIGS. 2 and 3, the first machine learning model group 210 includes the first direction position determination model 211, the second direction position determination model 212, the type determination model 213, and the direction determination model 214. Note that the first machine learning model group 210 does not have to include all of these machine learning models. Furthermore, the first machine learning model group 210 may include another machine learning model as long as individual figure information regarding a line segment is inferred for a plurality of line segments included in figure data.

As described with reference to FIGS. 2 and 3, the second machine learning model group 220 includes the projection/recess configuration determination model 221, the side determination model 222, the first figure internal direction determination model 223, and the second figure internal direction determination model 224. Note that the second machine learning model group 220 does not have to include all of these machine learning models. Furthermore, the second machine learning model group 220 may include another machine learning model as long as a relative relationship between one line segment among a plurality of line segments and another line segment among the plurality of line segments is inferred for the plurality of line segments included in figure data.

The past data acquisition unit 111 acquires a plurality of patterns of the past figure data 10. In an example, the past figure data 10 is a drawing created in the past. In an example, the past data acquisition unit 111 acquires 30 patterns or more, preferably 50 patterns or more of the past figure data 10.

The training data creation unit 112 creates a plurality of pieces of figure data in which information such as color of one line segment (for example, the line segment #1) is changed among the plurality of line segments #1 to #14 included in the plurality of past figure data 10. The training data creation unit 112 creates training data in which figure data and a correct answer label of one local feature are associated with each other for each line segment. The training data creation unit 112 creates a training data group according to each line segment and each local feature.

The training data group includes a first training data group 121 in which the figure data is associated with the correct answer label of each piece of the individual figure information such as the reference numerals (1) to (4) in FIG. 4, and a second training data group 122 in which the figure data is associated with the correct answer label of each relative relationship such as the reference numerals (5) to (8) in FIG. 4.

The training execution unit 113 trains the first machine learning model group 210 such as the first direction position determination model 211, the second direction position determination model 212, the type determination model 213, and the direction determination model 214 using the first training data group 121. The training execution unit 113 adjusts parameters of a hierarchical deep neural network of each model by machine learning. The adjusted parameters are stored in the storage unit 200.

Similarly, the training execution unit 113 trains the second machine learning model group 220 such as the projection/recess configuration determination model 221, the side determination model 222, the first figure internal direction determination model 223, and the second figure internal direction determination model 224 using the second training data group 122. The training execution unit 113 adjusts parameters of a hierarchical deep neural network of each model by machine learning.

### [C-2] Inference Phase

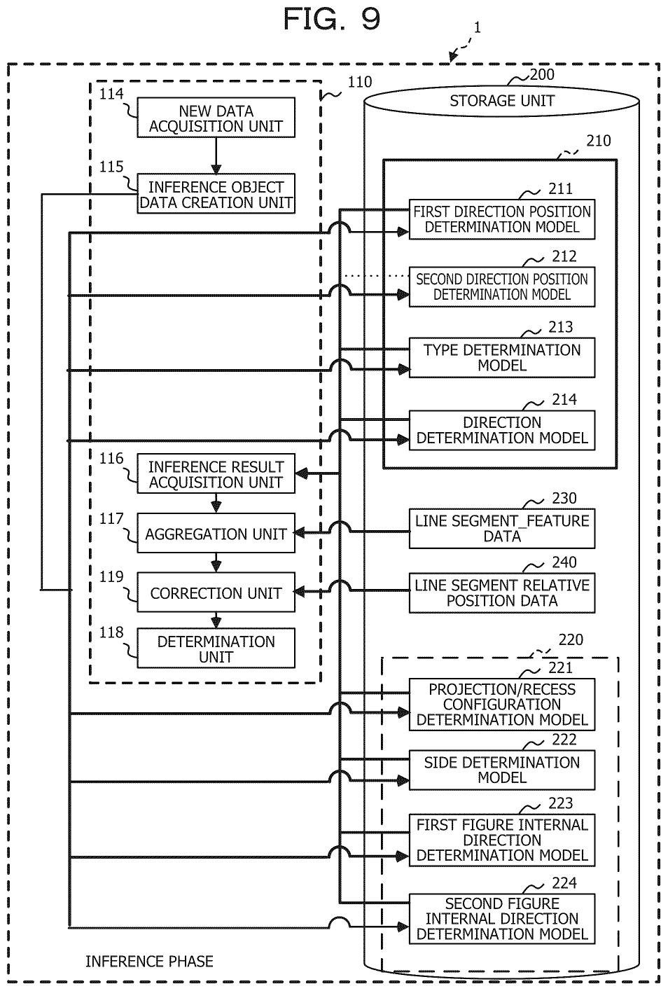

FIG. 9 is a block diagram illustrating a functional configuration example in the inference phase by the information processing device 1 according to the embodiment.

As illustrated in FIG. 9, the storage unit 200 may exemplarily store the first machine learning model group 210 and the second machine learning model group 220 that have been trained. Note that the first machine learning model group 210 and the second machine learning model group 220 that have been trained may be stored in a storage area outside the information processing device 1.

The storage unit 200 may store line segment feature data 230 and line segment relative position data 240.

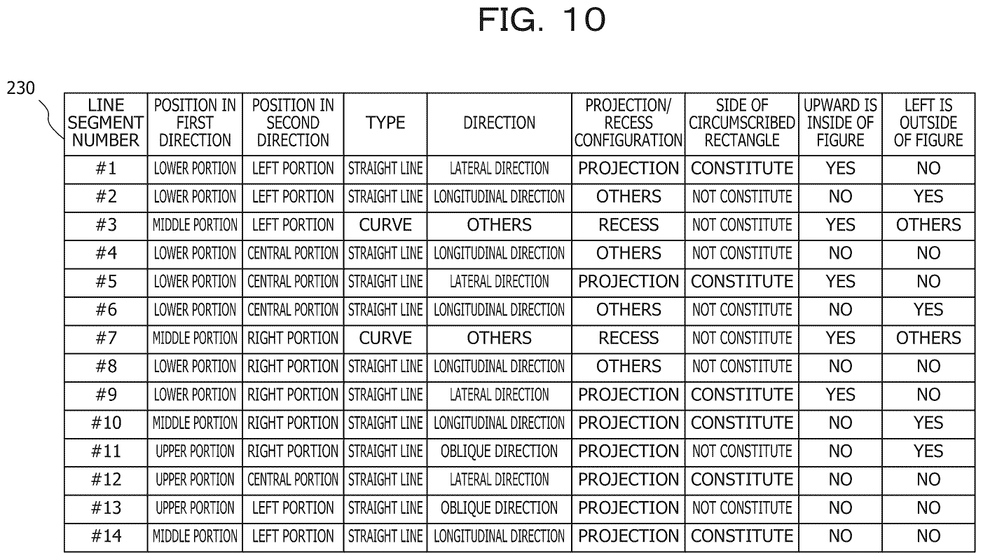

FIG. 10 is an example of the line segment feature data 230 indicating a relationship between each line segment and features in the past figure data 10.

As illustrated in FIG. 10, the line segment feature data 230 indicates relationships between the line segments #1 to #14 in the past figure data 10 serving as a reference of the dimensioning rule and a plurality of types of local features (for example, the reference numerals (1) to (8) and the like in FIG. 4) in each line segment. The line segment feature data 230 is an example of feature information indicating a plurality of items including both individual figure information and a relative relationship between line segments in the respective line segments #1 to #14 for each of the plurality of line segments #1 to #14 of the past figure data 10.

In an example, regarding the line segment #7 of the past figure data 10 illustrated in FIG. 1, as illustrated in FIG. 10, the line segment #7 has, as the individual figure information, a middle portion as a position in the first direction (for example, the longitudinal direction) and a right portion as a position in the second direction (for example, the horizontal direction). The line segment #7 has the local features of a curve as a type of the line segment and “others” as an extending direction of the line segment.

Furthermore, as the information regarding a relative relationship between the plurality of line segments, the line segment #7 constitutes the recess portion of the FIG. 12 that is the closed figure, constitutes a part of the sides (for example, contour) of the FIG. 12, has an upper side inside of the figure, and corresponds to “others” as to whether or not a left portion is inside of the figure.

The line segment feature data 230 may be input in advance by a user according to an input device such as the mouse 1051 or the keyboard 1052, or may be automatically generated by a computer.

The line segment relative position data 240 in FIG. 9 is the information regarding the relative positional relationships among the line segments #1 to #14. The line segment relative position data 240 is an example of constraints related to positions of line segments such as “the line segment #7 is positioned on the positive direction side (upper portion side) of Y than the line segment #3” and “the line segment #5 is positioned on the positive direction side of the X axis than the line segment #1”, taking the past figure data 10 illustrated in FIG. 1 as an example. Note that, in a case where a correction unit 119 does not execute correction of the line segment correspondence relationship based on prohibition, the storage unit 200 does not have to store the line segment relative position data 240.

As illustrated in FIG. 9, the control unit 110 includes a new data acquisition unit 114, an inference object data creation unit 115, an inference result acquisition unit 116, an aggregation unit 117, a determination unit 118, and the correction unit 119.

The new data acquisition unit 114 acquires the newly created figure data 20 serving as an object. The newly created figure data 20 is, for example, a drawing to be newly created. In an example, the new data acquisition unit 114 may acquire the newly created figure data 20 from the two-dimensional drawing creation unit 32 in FIG. 6.

The inference object data creation unit 115 creates image data to be inferred in which information such as color of one line segment (for example, the line segment #1-1) is changed among the plurality of line segments #1-1 to #14-1 included in the newly created figure data 20. The image data to be inferred created by the inference object data creation unit 115 is input to the selected first machine learning model group 210 and second machine learning model group 220 that have been trained.

The inference result acquisition unit 116 uses the selected first machine learning model group 210 and second machine learning model group 220 that have been trained to acquire the inference results 130 of the plurality of types of local features of the corresponding line segment number (#1-1). Similarly, the inference result acquisition unit 116 acquires the inference results 130 of the plurality of types of local features (reference numerals (1) to (8) and the like in FIG. 4) for each line segment number (#1-1 to #14-1). The inference results 130 of the plurality of types of local features are the respective inference results of the plurality of items including both the individual figure information and the information regarding a relative relationship.

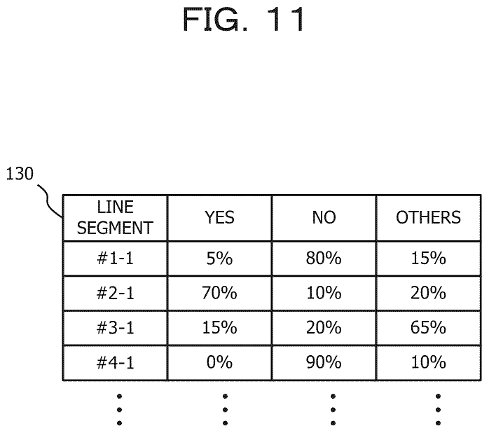

FIG. 11 is an example of the inference results 130 using the second figure internal direction determination model 224. The second figure internal direction determination model 224 infers whether or not the second direction (for example, left direction) is the inside of the FIG. 22 that is the closed figure with reference to a line segment.

FIG. 11 indicates the inference results 130 for the line segments #1-1, #2-1, #3-1, #4-1, . . . in the newly created figure data 20 of FIG. 1. As illustrated in FIG. 11, the inference results 130 may include an inference class of each local feature and a certainty factor thereof. The certainty factor may be a weight of a determination result of the class of the local feature. It is indicated that each machine learning model has made a determination with higher accuracy as a numerical value of the certainty factor is closer to 1.

For the line segment #1-1, a correct answer class is NO (for example, the left side of the line segment #1-1 is not inside of the figure), and in the inference results 130, a case is indicated where it is inferred that YES is 5%, NO is 80%, and others are 15%. For the line segment #2-1, the correct answer class is YES (for example, the left side of the line segment #2-1 is inside of the figure), and a case is indicated where it is inferred that YES is 70%, NO is 10%, and others are 20%. Similarly, for the line segment #3-1, the correct answer class is “others”, and a case is indicated where it is inferred that YES is 15%, NO is 20%, and others are 65%. For the line segment #4-1, the correct answer class is NO (for example, the left side of the line segment #4-1 is not inside of the figure), and a case is indicated where it is inferred that YES is 0%, NO is 90%, and others are 10%.

The aggregation unit 117 aggregates the inference results 130 of the plurality of types of local features for each of the line segment numbers (#1-1 to #14-1). In an example, the aggregation unit 117 aggregates the inference results 130 of the plurality of types of local features for each of the line segment numbers (#1-1 to #14-1).

FIG. 12 is a diagram illustrating an example of a voting method using the inference results 130. FIG. 12 is an example of an aggregation result table 43-1 using the inference results 130 for the line segment #1-1 illustrated in FIG. 11. For convenience of description, the aggregation result table 43-1 displays an aggregation field 431a for the characteristic whether the left is inside of the figure.

The aggregation unit 117 refers to the line segment feature data 230 illustrated in FIG. 10 and the inference results 130 illustrated in FIG. 11. The aggregation unit 117 inputs a certainty factor corresponding to a class of each feature of the past figure data 10 (for example, the basic line segments #1 to #14) serving as a reference among the inference results 130. For each of the basic line segments #1 to #14, the aggregation unit 117 inputs a certainty factor of “NO” (0.80) in the inference results 130 to portions where the inference results 130 are NO in the aggregation field 431a. The aggregation unit 117 inputs a certainty factor of “YES” (0.05) in the inference results 130 to portions where the inference results 130 are YES in the aggregation field 431a. Similarly, the aggregation unit 117 inputs a certainty factor of “others” (0.15) in the inference results 130 to portions where the inference results 130 are “others” in the aggregation field 431a.

The aggregation unit 117 aggregates the inference results 130 corresponding to blank fields of the aggregation result table 43-1 illustrated in FIG. 12. The aggregation unit 117 aggregates the inference results 130 for all the line segments #1-1 to #14-1 to be inferred.

The aggregation unit 117 may aggregate the blank fields of the aggregation result table 43-1 and calculate a total value obtained by summing the certainty factors of the inference results 130 for each of the line segments #1 to #14 of the past figure data 10 serving as a reference.

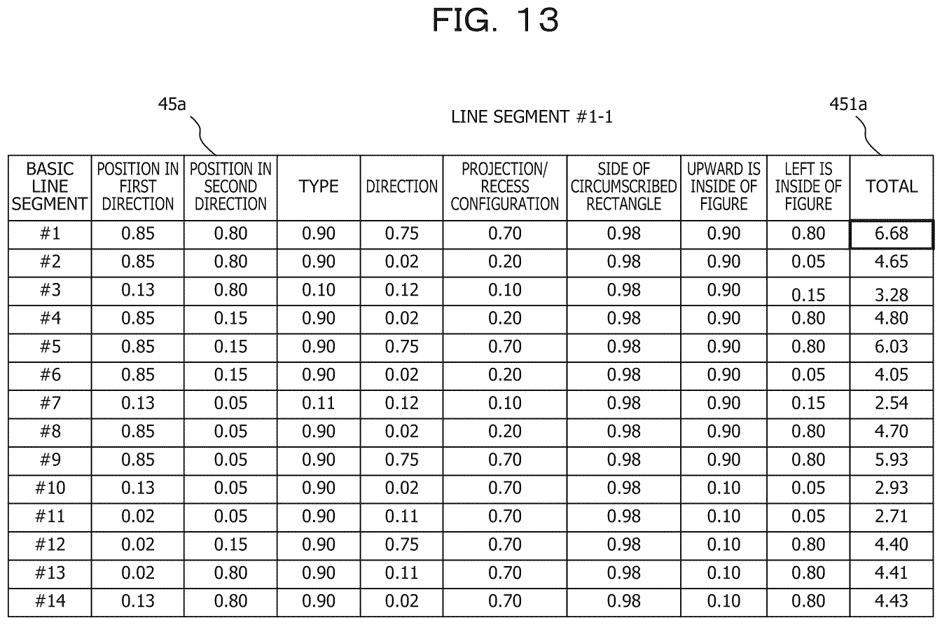

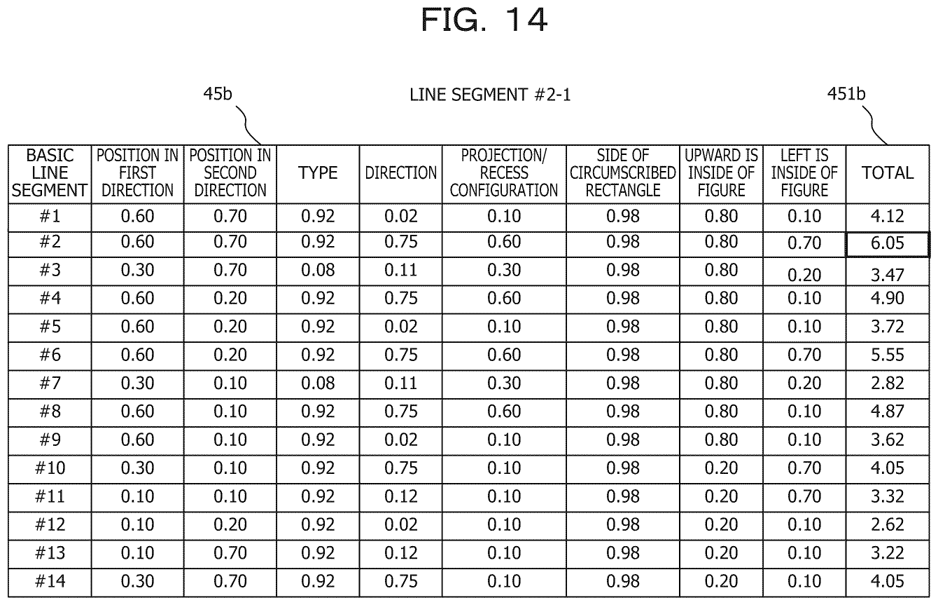

FIGS. 13 and 14 are examples of aggregation result tables 45 using the inference results 130. The aggregation result table 45 includes the total value obtained by summing the certainty factors of the inference results 130 for each of the line segments #1 to #14 of the past figure data 10 serving as a reference. FIG. 13 is an aggregation result table 45a for the line segment #1-1 to be inferred, and FIG. 14 is an aggregation result table 45b for the line segment #2-1 to be inferred. The aggregation result tables 45 are similarly created also for the line segments #3-1 to #14-1 to be inferred.

The total value of the certainty factors of the inference results 130 for each of the line segments #1 to #14 of the past figure data 10 serving as a reference is an example of a certainty factor regarding correspondence relationships between the line segments #1-1 to #14-1 of the newly created figure data 20 and the line segments #1 to #14 of the past figure data 10.

The aggregation unit 117 refers to the aggregation result tables 45 for the line segments #1-1 to #14-1 to be inferred, and selects the reference line segments #1 to #14 with the maximum certainty factor total value 451 (451a, 451b . . . ) for each of the line segments #1-1 to #14-1.

For the line segment #1-1, as illustrated in FIG. 13, the certainty factor total value 451 indicates the maximum value 6.68 in the line segment #1 serving as a reference. For the line segment #2-1, as illustrated in FIG. 14, the certainty factor total value 451 indicates the maximum value 6.05 in the line segment #2 serving as a reference. Similarly, the aggregation unit 117 acquires, also for the line segments #3-1 to #14-1, the line segments #1 to #14 with the maximum certainty factor total value 451 and the maximum certainty factor total value 451 at that time.

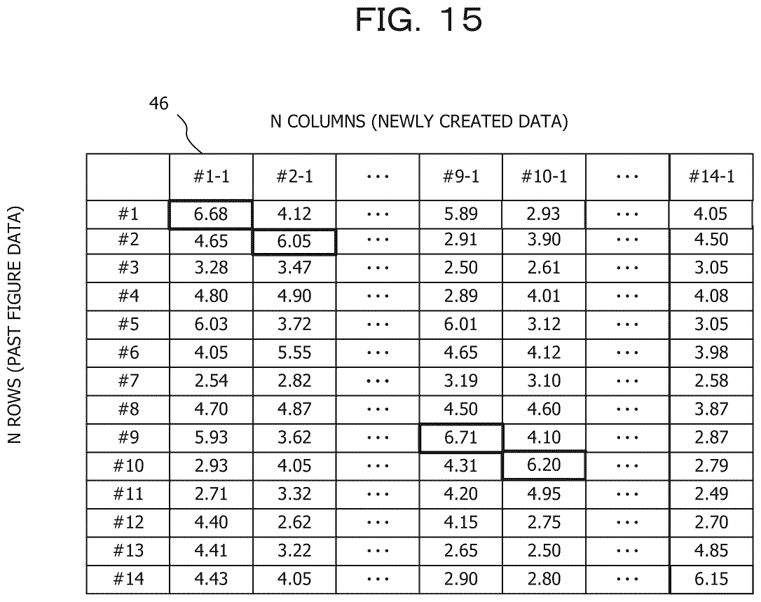

FIG. 15 is an example of an N square matrix 46 for calculating the correspondence relationship between each of the line segments #1 to #14 in the past figure data 10 and each of the line segments #1-1 to #14-1 in the newly created figure data 20. N may be the number of the line segments #1 to #14 in the past figure data 10.

In an example, the N square matrix 46 has the respective line segments #1 to #14 in the past figure data 10 as rows and the respective line segments #1-1 to #14-1 in the newly created figure data 20 as columns. Then, as each component of the N square matrix 46, there is the certainty factor total value 451 corresponding to a row and a column. The aggregation unit 117 generates the N square matrix 46.

The determination unit 118 illustrated in FIG. 9 determines the correspondence relationships between the line segments #1-1 to #14-1 and the line segments #1 to #14 of the past figure data 10 based on the inference results 130 of the plurality of items serving as the local features of the respective line segments #1-1 to #14-1 of the newly created figure data 20. The determination unit 118 determines the correspondence relationships between the line segments #1-1 to #14-1 and the line segments #1 to #14 of the past figure data 10 based on the certainty factor total value 451 that is the total value of the certainty factors of the inference results 130 for each of the line segments #1 to #14 of the past figure data 10 serving as a reference.

The determination unit 118 determines the correspondence relationships so as to have one-to-one correspondence in descending order of the certainty factor (for example, the certainty factor total value 451) regarding the correspondence relationships among the respective components of the N square matrix 46. Thus, the determination unit 118 selects a combination of a row and a column having the highest certainty factor total value 451 among the respective components of the N square matrix 46. In FIG. 15, the certainty factor total value 451 of a component having the line segment #9 in the past figure data 10 as a row and the line segment #9-1 in the newly created figure data 20 as a column is the highest. Therefore, the determination unit 118 determines the correspondence relationship between the line segment #9 and the line segment #9-1.

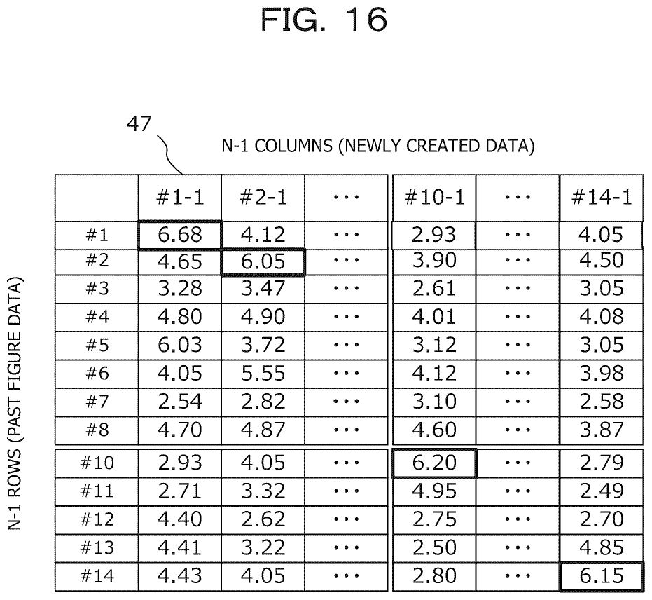

FIG. 16 is an example of an N−1 square matrix 47 obtained by removing the row and the column for which association has been completed. As illustrated in FIG. 16, the determination unit 118 removes the row and the column corresponding to the determined correspondence relationship to generate the N−1 square matrix 47.

The determination unit 118 determines the correspondence relationships so as to have one-to-one correspondence in descending order of the certainty factor (for example, the certainty factor total value 451) regarding the correspondence relationships among the respective components of the N−1 square matrix 47. In FIG. 16, the certainty factor total value 451 of the component having the line segment #10 in the past figure data 10 as a row and the line segment #10-1 in the newly created figure data 20 as a column is the highest. Therefore, the determination unit 118 determines the correspondence relationship between the line segment #10 and the line segment #10-1. The determination unit 118 removes the row and the column corresponding to the determined correspondence relationship to generate an N−2 square matrix (not illustrated).

Hereinafter, the determination unit 118 repeats similar processing for each line segment. As a result, the determination unit 118 determines all the correspondence relationships between each of the line segments #1 to #14 in the past figure data 10 and each of the line segments #1-1 to #14-1 in the newly created figure data 20.

The correction unit 119 illustrated in FIG. 9 corrects the correspondence relationship determined by the determination unit 118 based on a constraint of a relative positional relationship between two line segments included in the past figure data 10 serving as a reference.

In an example, the correction unit 119 refers to the line segment relative position data 240 to calculate presence or absence of a constraint violation of a relative position and the number of constraint violations. For example, a case will be considered where the determination unit 118 associates the line segment #3-1 with the line segment #7 and associates the line segment #7-1 with the line segment #3 in the example of FIG. 1. This association violates the constraint of the relative position “the line segment #7 is positioned on the positive direction side (upper portion side) of Y than the line segment #3” included in the line segment relative position data 240. The correction unit 119 may give a penalty point per violation.

In an example, the correction unit 119 generates pairs of the line segments (#3-1 and #7-1), (#2-1 and #5-1), . . . (s and t) in all the associated line segments #1-1 to #14-1. The correction unit 119 calculates a constraint violation degree obtained by summing the penalty points (for example, the number of violations) for all the pairs of line segments.

In a case where the constraint violation degree decreases by exchanging a correspondence relationship of the line segment s and a correspondence relationship of the line segment t, the correction unit 119 exchanges the correspondence relationship of the line segment s and the correspondence relationship of the line segment t. The correction unit 119 may correct the correspondence relationship so as to minimize the constraint violation degree by repeating the generation of the pair of the line segments, the exchange of the correspondence relationship for the pair of the line segments, and confirmation of a change in the constraint violation degree.

Note that the aggregation unit 117, the determination unit 118, and the correction unit 119 of the present embodiment are not limited to the case described in FIGS. 12 to 16.

Various methods may be adopted as long as, for each of the line segments #1-1 to #14-1 in the newly created figure data 20, the correspondence relationship with each of the line segments #1 to #14 of the past figure data 10 is determined based on the inference results 130 of each of the plurality of items including both the individual figure information and the information regarding the relative relationship between the line segments.

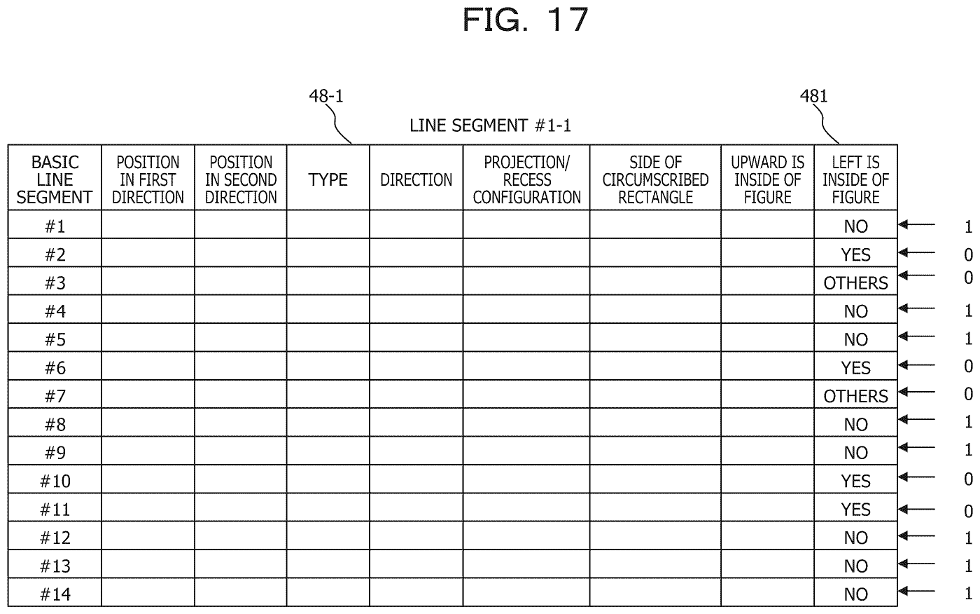

FIG. 17 is a diagram illustrating another example of the voting method using the inference results 130. FIG. 17 is an example of an aggregation result table 48-1 using the inference results 130 for the line segment #1-1 illustrated in FIG. 11. The aggregation result table 48-1 displays an aggregation field 481 for the characteristic whether the left is inside of the figure.

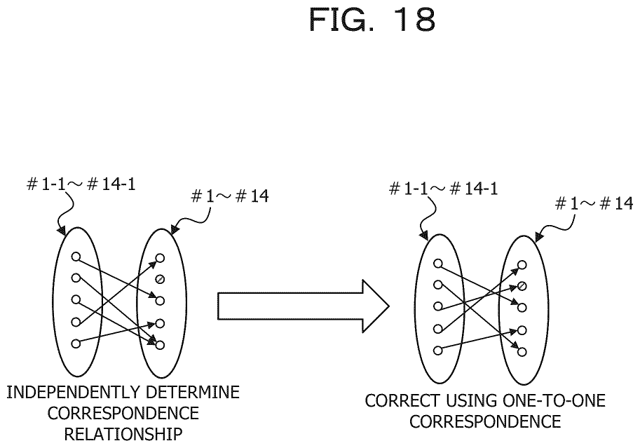

The aggregation unit 117 may adopt a simple voting method of voting one point for the inference result 130 having the highest certainty factor (YES) without aggregating the certainty factors considering weighting. In this case, as illustrated in FIG. 18, the aggregation unit 117 may vote “1” for #1, 4, 5, 8, 9, and 12 to #14 that apply to the inference results 130, and may vote “0” for #2, 3, 6, 7, 10, and 11 that do not apply to the inference results 130.

The determination unit 118 may independently determine, for the line segments #1-1 to #14-1, the association with the line segments #1 to #14, respectively. In the case illustrated in FIG. 13, the line segment #1-1 is associated with the line segment #1 having the highest certainty factor total value 451. In the case illustrated in FIG. 14, the line segment #2-2 is associated with the line segment #2 having the highest certainty factor total value 451.

FIG. 18 is a diagram for describing correction of association using one-to-one correspondence. The determination unit 118 may independently determine, for the line segments #1-1 to #14-1, the association with the line segments #1 to #14, and then, in a case where a plurality of line segments among the line segments #1-1 to #14-1 is overlapped and associated with a specific line segment among the line segments #1 to #14, correct the correspondence relationship. The determination unit 118 corrects the association such that, among the overlapped line segments #1-1 to #14-1, the line segments #1-1 to #14-1 having the higher certainty factor are given priority and have one-to-one correspondence.

Note that shapes of the FIG. 12 and the FIG. 22 are not limited to the case of the M-shape illustrated in FIG. 1.

### [D] Operation Example

### [D-1] Training Phase

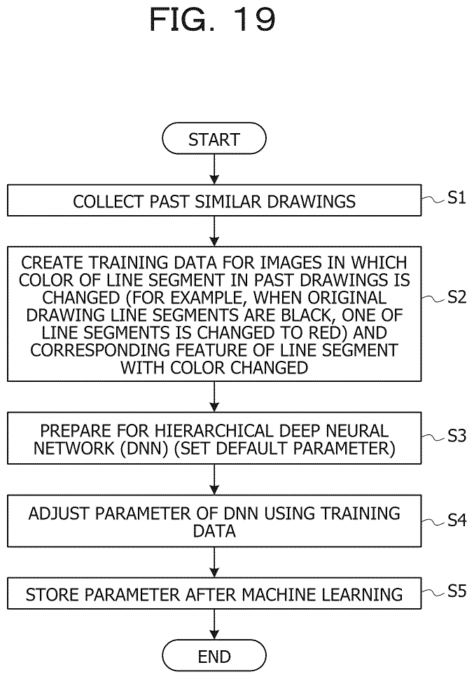

FIG. 19 is a flowchart illustrating an example of operation in the training phase by the information processing device 1 according to the embodiment.

As exemplified in FIG. 19, the past data acquisition unit 111 collects past similar drawings as the past figure data 10 (step S1).

The training data creation unit 112 creates training data (step S2). The training data creation unit 112 creates a plurality of images (for example, pieces of figure data) in which information such as color of one line segment (for example, the line segment #1) is changed among the plurality of line segments #1 to #14 included in the past drawings. In an example, the training data creation unit 112 changes one line segment in the original drawing to red and maintains the remaining line segments in black. The training data creation unit 112 creates training data in which the image is associated with a correct answer label of one corresponding local feature of the line segment in which the information such as color is changed for each line segment. The training data creation unit 112 creates a plurality of patterns of training data (training data group) according to the respective line segments #1 to #14 and the respective local features (reference numerals (1) to (8) and the like in FIG. 4).

The training data group includes the first training data group 121 in which the image is associated with the correct answer label of each piece of the individual figure information and the second training data group 122 in which the image is associated with the correct answer label of each relative relationship between the plurality of line segments.

The training execution unit 113 prepares for training of the first machine learning model group 210 and the second machine learning model group 220 including a DNN and the like (step S3). The training execution unit 113 sets a default parameter as a parameter of each layer of the DNN.

The training execution unit 113 trains the first machine learning model group 210 and the second machine learning model group 220 including the DNN and the like using the plurality of patterns of training data (training data group). For example, the training execution unit 113 updates the parameter of each layer of the DNN (step S4).

The training execution unit 113 stores the parameter after machine learning in the storage unit 200 or the like (step S5). For example, the first machine learning model group 210 and the second machine learning model group 220 that have been trained are stored in the storage unit 200 or the like.

### [D-2] Inference Phase

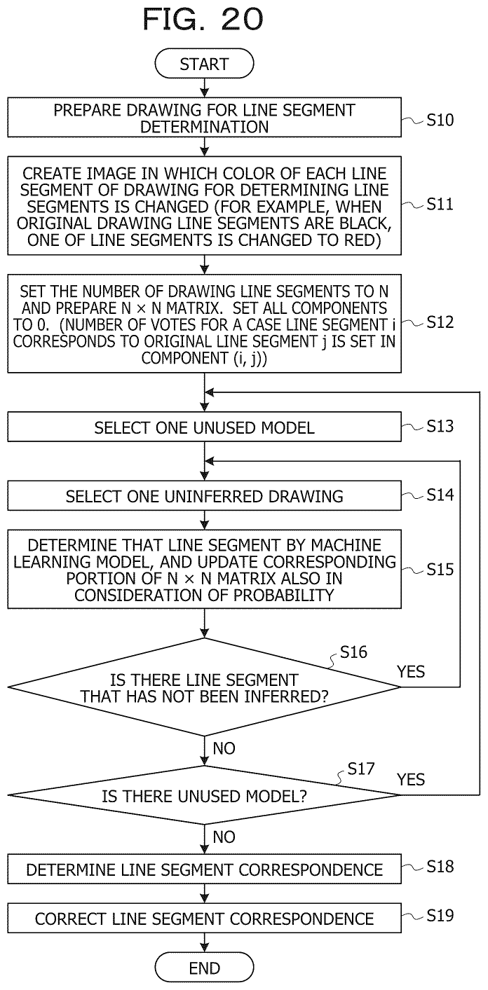

FIG. 20 is a flowchart illustrating an example of operation in the inference phase by the information processing device 1 according to the embodiment.

As exemplified in FIG. 20, the new data acquisition unit 114 prepares an object drawing for determining a correspondence relationship between line segments (step S10). For example, the new data acquisition unit 114 prepares newly created figure data.

The inference object data creation unit 115 creates an image to be inferred in which information such as color of one line segment (for example, the line segment #1-1) is changed among the plurality of line segments #1-1 to #14-1 included in the object drawing for determining the correspondence relationship between the line segments (step S11). The image to be inferred (for example, drawing to be inferred) is created for each of the line segments #1-1 to #14-1.

When the number of drawing line segments is set to N, the determination unit 118 prepares an N×N N square matrix 46a. The determination unit 118 sets components of the N×N N square matrix 46a to initial values (for example, 0) (step S12). For example, the determination unit 118 sets each of the line segments #1 to #14 in the original drawing serving as a reference (for example, the past figure data 10) as a row, and sets each of the line segments #1-1 to #14-1 in the object drawing for determining the correspondence relationship between the line segments (for example, the newly created figure data 20) as a column. The determination unit 118 may set each of the line segments #1-1 to #14-1 as a row and each of the line segments #1 to #14 as a column. A component (i, j) (i is a row and j is a column) is updated by the number of votes obtained (for example, the certainty factor total value 451) for a case where the row is the line segment of the original figure and is inferred to correspond to the column which is the line segment of the object drawing for which the correspondence relationship between the line segments should be determined.

The inference result acquisition unit 116 selects one unselected machine learning model from among the trained machine learning models included in either the first machine learning model group 210 or the second machine learning model group 220 (step S13).

The inference result acquisition unit 116 selects an uninferred drawing among the drawings to be inferred (in which, for example, the line segments in which the information such as color is changed are different) having the same number of types as the number of line segments (step S14).

The inference result acquisition unit 116 uses the selected machine learning model to determine a local feature of the line segment in which the information such as color is changed of the selected drawing (step S15). The inference result acquisition unit 116 may include, as the inference results 130, a feature to be inferred and a certainty factor (probability) in the inference. The aggregation unit 117 updates the component of the N square matrix 46a by the obtained certainty factor (the number of votes) (step S15).

The inference result acquisition unit 116 determines whether there is a line segment that has not been inferred by the selected machine learning model (step S16). In a case where there is a line segment that has not been inferred (see Yes route of step S16), the processing returns to step S14. In a case where all the line segments have been inferred by the selected machine learning model (see No route in step S16), the processing proceeds to step S17.

The inference result acquisition unit 116 determines whether there is a machine learning model that has not been selected (step S17). In a case where there is a machine learning model that has not been selected (see Yes route of step S17), the processing returns to step S13. In a case where all the machine learning models have been selected and inference of the correspondence relationships of all the line segments has been completed by all the selected machine learning models (see No route in step S17), the processing proceeds to step S18. In the processing from step S13 to step S17, the aggregation unit 117 completes the update of the N square matrix 46 exemplified in FIG. 15.

The determination unit 118 determines the correspondence relationships between the line segments of the original FIG. 12 and the line segments of the FIG. 22 to be inferred so as to have one-to-one correspondence in descending order of the certainty factor (for example, the certainty factor total value 451) regarding the correspondence relationships among the respective components of the N square matrix 46. The determination unit 118 generates the N−1 square matrix 47 obtained by removing the row and the column for which association has been completed, and determines the correspondence relationships between the line segments of the original FIG. 12 and the line segments of the FIG. 22 to be inferred so as to have one-to-one correspondence in descending order of the certainty factor (for example, the certainty factor total value 451) regarding the correspondence relationships. Similarly, the determination unit 118 determines the correspondence relationships between all the line segments of the original FIG. 12 and all the line segments of the FIG. 22 to be inferred (step S18).

The correction unit 119 corrects the correspondence relationship determined by the determination unit 118 based on the constraint of the relative positional relationship between two line segments included in the past figure data 10 serving as a reference (step S19).

### [E] Working Example

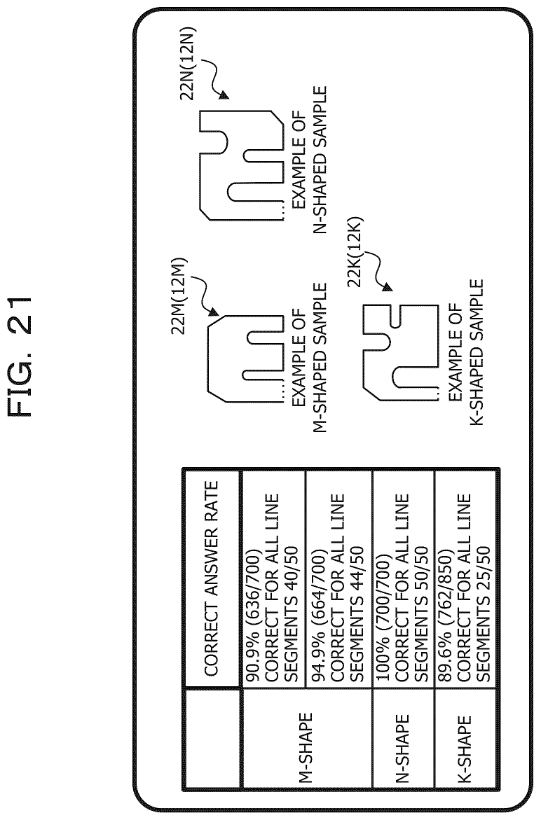

FIG. 21 is a diagram illustrating an example of a working example. FIG. 21 illustrates a working example in a case where the FIG. 22 in the newly created figure data 20 includes a sample of an M-shaped FIG. 22M, a sample of an N-shaped FIG. 22N, and a sample of a K-shaped FIG. 22K. Note that the FIG. 12 in the past figure data 10 also includes an M-shaped FIG. 12M, an N-shaped FIG. 12N, and a K-shaped FIG. 12K.

The M-shaped FIG. 22M (12M) has two slit portions extending toward a direction from one side to the other side in a pair of opposing sides. The N-shaped FIG. 22N (12N) has two slit portions extending toward a direction from one side to the other side in a pair of opposing sides, and conversely has one slit portion extending toward a direction from the other side to the one side. The K-shaped FIG. 22K (12K) has one slit extending in a direction from one side to the other side in a pair of opposing sides, conversely has one slit extending toward a direction from the other side to the one side, and has one slit in a side coupling between the pair of opposing sides.

The working example illustrated in FIG. 21 is a case where training and inference of the first machine learning model group 210 and the second machine learning model group 220 are performed using 50 pieces (50 patterns) of the past figure data 10. By determining the correspondence relationship of the line segments using the inference results 130 of the plurality of local features as in the present case, it is possible to set the correct answer rate of the line segment number determination in the newly created figure data 20 to 90% even in a case where the amount of the training data may not be sufficiently prepared. For example, the amount of the past figure data 10 for setting the correct answer rate of the line segment number determination in the newly created figure data 20 to 90% may be reduced to 50/1000=1/20.

In the above embodiment, the case where the correspondence relationships between the plurality of line segments included in the past figure data 10 and the plurality of line segments included in the newly created figure data 20 are determined has been described as an example, but the information processing device 1 is not limited to this case. The information processing device 1 may be widely applied to the case of determining the correspondence relationships of the line segments between the first figure data and the second figure data different from each other. The information processing device 1 may be suitably used in a case where the first figure data and the second figure data include similar figures.

### [F] Effects of One Embodiment

According to the example of the embodiment described above, the following working effects may be obtained, for example.

The first machine learning model group 210 (210a) infers, for each of the first plurality of line segments included in the first figure data (for example, the newly created figure data 20), individual figure information (for example, at least one of the reference numerals (1) to (4) in FIG. 4) of one line segment among the first plurality of line segments. The second machine learning model group 220 (220a) infers a relative relationship (for example, at least one of the reference numerals (5) to (8) in FIG. 4) between one line segment among the first plurality of line segments and another line segment of the first figure data. The inference result acquisition unit 116 uses the first machine learning model group 210 and the second machine learning model group 220 to acquire the inference results 130 of each of a plurality of items including the individual figure information and the information regarding the relative relationship. The determination unit 118 determines correspondence relationships between the first plurality of line segments and the second plurality of line segments included in the second figure data different from the first figure data based on the respective inference results 130 of the plurality of items for each of the first plurality of line segments.

As a result, an amount of training data needed for accurately determining the correspondence relationships between the line segments of the first figure data and the second figure data may be reduced. For example, even in a case where the amount of the training data is small, the correspondence relationships between the line segments of the first figure data and the second figure data may be accurately determined.

The individual figure information includes at least one piece of information of a position of a line segment, a direction of the line segment, and a curvature of the line segment. The information regarding the relative relationship includes at least one piece of information of information regarding whether or not the one line segment constitutes a recess portion or a projection portion of the figure, information regarding whether or not the one line segment constitutes a side of a circumscribed rectangle for the closed figure, and information regarding a relationship between the one line segment and an internal area of the closed figure.

As a result, even in a case where it is difficult to detect positions of centers of gravity and both end points of line segments by image processing and determine correspondence relationships between the line segments, the correspondence relationships of the line segments may be determined.

The processing of determining the correspondence relationships includes processing of acquiring, for each of the second plurality of line segments, the line segment feature data 230 indicating a plurality of items including individual figure information regarding one line segment in the second plurality of line segments and a relative relationship between the one line segment in the second plurality of line segments and another line segment in the second figure data. The aggregation unit 117 uses the line segment feature data 230 and the inference results 130 to aggregate the certainty factor total value 451 for each correspondence relationship between each line segment of the first plurality of line segments and each line segment of the second plurality of line segments. The determination unit 118 determines the correspondence relationships such that the correspondence relationships have one-to-one correspondence in descending order of the certainty factor total value 451 of the correspondence relationships.

As a result, since the correspondence relationships are determined using the one-to-one correspondence between the line segments, determination accuracy of the correspondence relationships may be improved.

The correction unit 119 corrects the correspondence relationship based on a relative positional relationship between two line segments included in the second plurality of line segments.

As a result, the determination accuracy of the correspondence relationships may be further improved.

The control unit 110 or the annotated drawing generation unit 36 acquires notation positions and modes of the dimensional annotations 13 added to a part of the second plurality of line segments of the second figure data. The control unit 110 or the annotated drawing generation unit 36 adds, based on the determined correspondence relationships, the dimensional annotations 26 in the first figure data in correspondence with the positions and the modes in which the dimensional annotations 13 have been added in the second figure data.

As a result, in the case of dimensioning a newly created figure, the dimensioning work may be performed by utilizing similar drawings in the past. The dimensional annotations 26 of the new drawing may be added following the dimensional annotations 13 of the past drawings that conform to different rules depending on an industry type, business, a company, and a department. For example, even in a case where there are about several tens of past drawings for training data creation, it is possible to determine correspondence relationships of line segments between the newly created drawing and the past drawings with a correct answer rate of 90% or more, and to add the dimensional annotations 26 based on a determination result.

As an effect in an assumed business scene, in a case where training data is limited, the present embodiment may be widely used for application of inferring correspondence relationships of line segments between figures similar to each other. For example, in drawing using a CAD software, dimensioning corresponding to a unique dimensioning rule of each user in past drawings may be reflected in a drawing to be newly created, which may contribute to promotion of digital transformation in a manufacturing industry.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a correspondence relationship determination program for causing a computer to execute a process comprising:
acquiring, using a first machine learning model that infers individual figure information regarding one line segment in a first plurality of line segments included in first figure data and a second machine learning model that infers information regarding a relative relationship between the one line segment in the first plurality of line segments and another line segment in the first figure data, an inference result of each of a plurality of items that includes the individual figure information and the information regarding the relative relationship, for each of the first plurality of line segments; and
determining correspondence relationships between the first plurality of line segments and a second plurality of line segments included in second figure data different from the first figure data based on the inference result of each of the plurality of items for each of the first plurality of line segments.

2. The non-transitory computer-readable recording medium according to claim 1, wherein
the individual figure information includes information regarding a position of the line segment, a direction of the line segment, or a curvature of the line segment, or any combination thereof, and
the information regarding the relative relationship includes information regarding whether or not the one line segment constitutes a recess portion or a projection portion in the first figure data, information regarding whether or not the one line segment constitutes a side of a circumscribed rectangle for a closed figure in the first figure data, or information regarding a relationship between the one line segment and an internal area of the closed figure, or any combination thereof.

3. The non-transitory computer-readable recording medium according to claim 1, wherein the processing of determining the correspondence relationships includes:
acquiring, for each of the second plurality of line segments, feature information that indicates a plurality of items that includes individual figure information regarding one line segment among the second plurality of line segments and a relative relationship between the one line segment among the second plurality of line segments and another line segment in the second figure data;
aggregating a certainty factor for each correspondence relationship between each line segment of the first plurality of line segments and each line segment of the second plurality of line segments by using the feature information and the inference result; and
determining the correspondence relationships such that the correspondence relationships have one-to-one correspondence in descending order of the certainty factor for the correspondence relationships.

4. The non-transitory computer-readable recording medium according to claim 1, the process further comprising:
correcting the correspondence relationship based on a relative positional relationship between two line segments included in the second plurality of line segments.

5. The non-transitory computer-readable recording medium according to claim 1, the process further comprising:
acquiring information regarding first dimensional notations added to a part of the second plurality of line segments of the second figure data, and adding second dimensional notations in the first figure data in correspondence with positions and modes in which the first dimensional notations are added in the second figure data based on the determined correspondence relationships.

6. A correspondence relationship determination method performed by a computer, the method comprising:
acquiring, using a first machine learning model that infers individual figure information regarding one line segment in a first plurality of line segments included in first figure data and a second machine learning model that infers information regarding a relative relationship between the one line segment in the first plurality of line segments and another line segment in the first figure data, an inference result of each of a plurality of items that includes the individual figure information and the information regarding the relative relationship, for each of the first plurality of line segments; and
determining correspondence relationships between the first plurality of line segments and a second plurality of line segments included in second figure data different from the first figure data based on the inference result of each of the plurality of items for each of the first plurality of line segments.

7. The correspondence relationship determination method according to claim 6, wherein
the individual figure information includes information regarding a position of the line segment, a direction of the line segment, or a curvature of the line segment, or any combination thereof, and
the information regarding the relative relationship includes information regarding whether or not the one line segment constitutes a recess portion or a projection portion in the first figure data, information regarding whether or not the one line segment constitutes a side of a circumscribed rectangle for a closed figure in the first figure data, or information regarding a relationship between the one line segment and an internal area of the closed figure, or any combination thereof.

8. The correspondence relationship determination method according to claim 6, wherein the processing of determining the correspondence relationships includes:
acquiring, for each of the second plurality of line segments, feature information that indicates a plurality of items that includes individual figure information regarding one line segment among the second plurality of line segments and a relative relationship between the one line segment among the second plurality of line segments and another line segment in the second figure data;
aggregating a certainty factor for each correspondence relationship between each line segment of the first plurality of line segments and each line segment of the second plurality of line segments by using the feature information and the inference result; and
determining the correspondence relationships such that the correspondence relationships have one-to-one correspondence in descending order of the certainty factor for the correspondence relationships.

9. The correspondence relationship determination method according to claim 6, the method further comprising:
correcting the correspondence relationship based on a relative positional relationship between two line segments included in the second plurality of line segments.

10. The correspondence relationship determination method according to claim 6, the method further comprising:
acquiring information regarding first dimensional notations added to a part of the second plurality of line segments of the second figure data, and adding second dimensional notations in the first figure data in correspondence with positions and modes in which the first dimensional notations are added in the second figure data based on the determined correspondence relationships.

11. An information processing device comprising:
a memory, and
a processor coupled to the memory and configured to:
acquire, using a first machine learning model that infers individual figure information regarding one line segment in a first plurality of line segments included in first figure data and a second machine learning model that infers information regarding a relative relationship between the one line segment in the first plurality of line segments and another line segment in the first figure data, an inference result of each of a plurality of items that includes the individual figure information and the information regarding the relative relationship, for each of the first plurality of line segments; and
determine correspondence relationships between the first plurality of line segments and a second plurality of line segments included in second figure data different from the first figure data based on the inference result of each of the plurality of items for each of the first plurality of line segments.

12. The information processing device according to claim 11, wherein
the individual figure information includes information regarding a position of the line segment, a direction of the line segment, or a curvature of the line segment, or any combination thereof, and
the information regarding the relative relationship includes information regarding whether or not the one line segment constitutes a recess portion or a projection portion in the first figure data, information regarding whether or not the one line segment constitutes a side of a circumscribed rectangle for a closed figure in the first figure data, or information regarding a relationship between the one line segment and an internal area of the closed figure, or any combination thereof.

13. The information processing device according to claim 11, wherein in the determine the correspondence relationships, the processor is further configured to:
acquire, for each of the second plurality of line segments, feature information that indicates a plurality of items that includes individual figure information regarding one line segment among the second plurality of line segments and a relative relationship between the one line segment among the second plurality of line segments and another line segment in the second figure data;
aggregate a certainty factor for each correspondence relationship between each line segment of the first plurality of line segments and each line segment of the second plurality of line segments by using the feature information and the inference result; and
determine the correspondence relationships such that the correspondence relationships have one-to-one correspondence in descending order of the certainty factor for the correspondence relationships.

14. The information processing device according to claim 11, the processor is further configured to:
correct the correspondence relationship based on a relative positional relationship between two line segments included in the second plurality of line segments.

15. The information processing device according to claim 11, the processor is further configured to:
acquire information regarding first dimensional notations added to a part of the second plurality of line segments of the second figure data; and
add second dimensional notations in the first figure data in correspondence with positions and modes in which the first dimensional notations are added in the second figure data based on the determined correspondence relationships.
